(19) United States
(12) Patent Application Publication
(10) Pub. No.: US 2009/0184680 A1
(43) Pub. Date: Jul. 23, 2009

(54) MAGNETIC INDUCTION AND ENERGY STORAGE SYSTEM, APPARATUS AND USE THEREOF

(75) Inventors: FU-JEN KAO, TAIPEI (TW); CHENG-CHUN LI, TAIPEI (TW)

Correspondence Address: WPAT, PC;INTELLECTUAL PROPERTY ATTORNEYS, 2030 MAIN STREET, SUITE 1300, IRVINE, CA, 92614, US

(73) Assignee: National Yang-Ming University, Taipei (TW)

(21) Appl. No.: 12/358,733

(22) Filed: Jan. 23, 2009

(30) Foreign Application Priority Data
Jan. 23, 2008 (CN) 200810005194.9

(51) Int. Cl. H02J 7/02

(52) U.S. Cl. 320/108

(57) ABSTRACT

The present invention relates to a magnetic induction and energy storage system, apparatus and use thereof. The present invention could be used with a biosensor implanted in a living organism, as a micro electrical device, or for other purposes.

### FIELD OF THE INVENTION

The present invention relates to a magnetic induction and energy storage system, apparatus, use thereof, a generalized magnetic induction and energy storage system, and an isotropic magnetic induction and energy storage device which could be used with a biosensor implanted in a living organism, as a micro electrical device, or for other purposes.

### BACKGROUND OF THE INVENTION

In 1831, Michael Faraday discovered that if a coil was placed in a varying magnetic field, electrical currents would generate due to changing magnetic flux. The Russian physicist H. F. E. Lenz proposed Lenz's Law, stating that any induced electromotive force would be in the direction such that the flux it created would always oppose the change in the flux that produced it.

Faraday's Law states that when a magnetic field passes a coil, an induced electromotive force, ε, which equals −N(dΦ_{B}/dt), will arise. N is the number of turns in the coil, and (dΦ_{B}/dt) is the rate of change of magnetic flux, which is correlated to the strength of the magnetic field, B, and the area of the coil, A.

Φ=∫B·dA=∫B(cos θ)(dA)

In this era of massive technological advances, a lot of biosensors could be implanted inside the human body. However, due to the lack of proper power, these devices usually could not function for an extended period of time, leading to losses of practical values Appliances or electronics devices depend on electricity to function. The conventional way of supplying or storing electricity is to connect through electrodes from a rechargeable battery or a power source. This approach might cause unwanted damage due to exposed electrodes or sparks arising from contacting of them.

R.O.C. patent No. 092137227 discloses an induction module which is composed of an induction coil bundled with a rechargeable battery. It functions by using electromagnetic induction to convert the magnetic flux transmitted from the charging end to electricity to charge the rechargeable battery. However, this design did not take into account the anisotropy of magnetic induction. This patent is addressing this orientation concern so that the induction charging will no longer sensitive to the direction of magnetic field.

### BRIEF DESCRIPTION OF THE DRAWINGS

FIG. 1 is the magnetic induction and energy storage system of the present invention.

FIG. 2 is a schematic diagram of the generalized magnetic induction and energy storage system.

FIG. 3 is the isotropic magnetic field induction and energy storage device of the present invention.

FIG. 4 is the soft magnetic core evenly wrapped with high frequency wires.

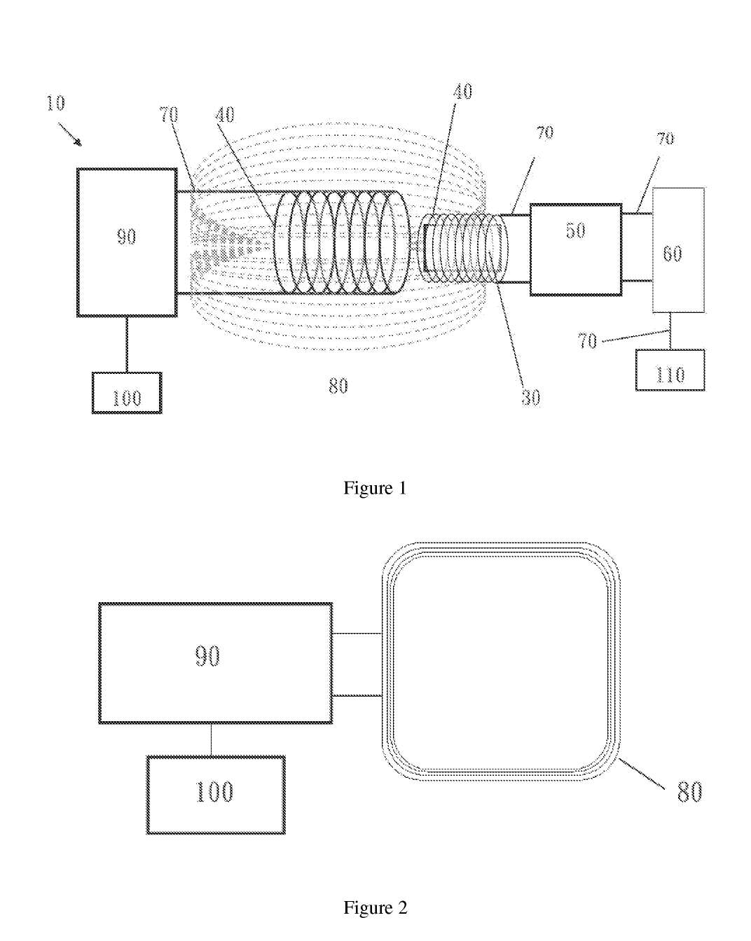

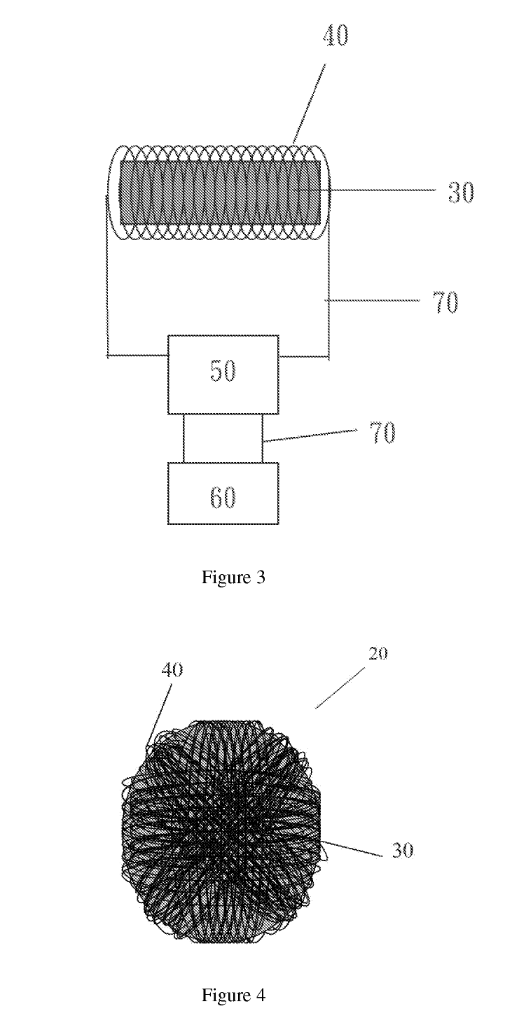

### DETAILED DESCRIPTION OF THE INVENTION

Compared to the conventional induction chargers, the present invention provides better efficiency through the use of high frequency magnetic field and isotropy between the primary and the secondary coils. Through multiply oriented secondary coils, the angular range of inactive orientation is minimized. The magnetic field induction and energy storage system of the present invention is utilizing high frequency alternating magnetic field on a primary coil.

The conventional way of charging and storage of energy is usually achieved through the contact of electrodes on a power source. However, the contacting of electrodes may induce spark, presenting higher risk near the inflammable substance or environment. The use of induction based on charging and energy storage system of the present invention can greatly reduce the risks. The system of the present invention comprises of magnetic field generating and receiving ends. The receiving end converts the induced alternative current into charging DC current through a rectifying circuit.

The magnetic induction and energy storage device of the present invention is the sue of a hollow circle completely covered by an enamel-insulated wire completely covered with a hollow circle to enclose the main part inside. In particular, the device of the present invention provides minimized-angular range of inactive orientation, solution of short dueability of prior art and limitation of space area and significantly enhances safety in usage. In addition, “universal compatibility” used herein means that the device of the present invention is applicable to any appliances that require a magnetic induction and energy storage instrument.

Therefore, the present invention provides a magnetic induction and energy storage system comprising:

(a) an all-purpose magnetic field generator to generate a strong magnetic field of alternative high frequency; and

(b) a magnetic induction and energy storage device to receive the magnetic field generated by the all-purpose magnetic field generator; the device comprising:
(i) a magnetizable core comprising at least two magnetic objects of low hysteretic coefficient material, wherein the objects are aligned at perpendicular angles to each other to store the induced current; and
(ii) a coil, which is wrapped around the magnetizable core based on the three axes (X, Y and Z) or any two of the three axes to generate an induced current.

The magnetic objects of low hysteresis coefficient in the magnetic induction and energy storage device of the present invention are in a shape of column, and are arranged in type of perpendicular to each other. These material of the objects are selected from the group consisting of soft magnets, cobalt and nickel.

The magnetic field generator in the present invention is capable of generating a strong high frequency alternating magnetic field, and is coupled to the magnetic induction and energy storage device of the present invention. This magnetic induction and energy storage device further comprises a rectifying circuit, and a battery or a capacitor to store the induced electricity. In a preferred embodiment, the magnetic field generator further comprises an object wrapped with a high frequency high density coil, a current-detecting circuit and a panel for controlling function. The object includes but is not limited to a container, a clothes (such as a jacket containing a high frequency high density coil), a blanket and so on.

The magnetic induction and energy storage system of the present invention is capable of being used as a power supply system that can charge remotely or supply electricity directly.

The present invention further provides a magnetic induction and energy storage device comprising:
(i) a magnetizable core comprising at least two magnetic objects of low hysteretic coefficient material, wherein the objects are aligned at perpendicular angles to each other to store the induced current; and
(ii) a coil, which is wrapped around the magnetizable core based on the three axes (X, Y and Z) or any two of the three axes to generate an induced current.

In a preferred embodiment, the magnetizable core is independently wrapped by two coils based on two of three axes. In a more preferred embodiment, the magnetizable core is independently wrapped by three coils based on three axes (X, Y and Z) to generate an induction of isotropic magnetic field. The device of the present invention is especially applicable to a biosensor implanted into a living organism.

The coil in the magnetic induction and energy storage device of the present invention is a enameled wire, preferably a high frequency high density wire, to stand a strong current and a high frequency magnetic field.

The magnetic induction and energy storage device of the present invention is operably connected to a biosensor such as one implanted in a living organism. In an embodiment, a high frequency coil for receiving magnetic field, a rectifying circuit, a rechargeable battery and a biosensor are connected through a wire. In a more preferred embodiment, a high frequency coil for receiving magnetic field, a rectifying circuit, a rechargeable battery and a biosensor are implanted in a living organism to enable the biosensor a longer lifespan and higher safety. The term “biosensor” used herein includes but is not limited to a charge-coupled device for long-term in vivo inspection, a pacemaker and a powering miniature valve or a switch. The present invention enables more stable and longer usage of the power stored in the biosensor.

The isotropic magnetic field induction and energy storage device of the present invention is operably connected to a toy or a household appliance. For example, the isotropic magnetic field induction and energy storage device of the present invention is installed into an automatic vacuum cleaner that needs to be frequently charged. This would enable the appliance to be remotely and magnetically charged through the use of the system of the present invention.

The examples below are non-limiting and are merely representative of various aspects and features of the present invention.

### EXAMPLES

### Example 1

### Preparation of the Magnetic Induction and Energy Storage System 10

According to Faraday's Law, and the system of the present invention combined a high frequency alternating magnetic field generator with a coil to generate an alternating magnetic field. Due to magnetic induction, the isotropic magnetic field induction and energy storage device of the present invention induced an alternating electric current in the coil and the current could be stored in the device of the present invention.

The device of the present invention was prepared as follows:

1) arranging three soft magnet cores 30 in type of perpendicular to each other; and

2) wrapping high frequency enameled wire evenly around three axes (X, Y and Z) of the soft magnetic cores to form isotropic magnetic induction and energy device 20 as depicted in FIG. 4. This device was then connected to a rectifying device 50, a micro-lithium battery 60 and a biosensor 110 through a wire 70.

A commercial or self-made modularized high frequency alternating magnetic induction circuit 90 was able to control an container externally wrapped with a high frequency high density coil. Upon the circuit was turned on, a high frequency alternating magnetic field 80 was generated. In addition, the circuit was connected to a panel for controlling function 100 to monitor the progress.

### Example 2

### Embodiment of a Biosensor Implanted in a Living Organism

A patient who had a pacemaker connected to the magnetic induction and energy storage device of the present invention put on a jacket equipped with a high frequency high density coil everyday at a fixed time. After activating of the magnetic induction and energy storage system of the present invention, the pacemaker was charged remotely through the magnetic induction and energy storage device. There were no worries about having to take out the pacemaker for charging.

What is claimed is:

1. A magnetic induction and energy storage system comprising:
(a) an all-purpose magnetic field generator to generate a strong magnetic field of alternative high frequency; and
(b) a magnetic induction and energy storage device to receive the magnetic field generated by the all-purpose magnetic field generator; the device comprising:
(i) a magnetizable core comprising at least two magnetic objects of low hysteretic coefficient material, wherein the objects are aligned at perpendicular angles to each other to store the induced current; and
(ii) a coil, which is wrapped around the magnetizable core based on the three axes (X, Y and Z) or any two of the three axes to generate an induced current.

2. The system as claimed in claim 1, wherein the magnetic objects are in a shape of column.

3. The system as claimed in claim 1, wherein the magnetic objects are selected from the group consisting of soft magnets, cobalt and nickel.

4. The system as claimed in claim 1, wherein the coil has two coils for wrapping independently around the magnetizable core based on two of the three axes.

5. The system as claimed in claim 1, wherein the coil has three coils for wrapping independently around the magnetizable core based on three axes (X, Y and Z).

6. The system as claimed in claim 1, wherein the magnetic field generator further comprises an object wrapped with a high frequency high density coil, a current-detecting circuit and a panel for controlling function.

7. The system as claimed in claim 6, wherein the object is a container, a clothe or a blanket.

8. The system as claimed in claim 1, wherein the magnetic induction and energy storage device further comprises a rectifying circuit, a battery or capacitor.

9. The system as claimed in claim 1, which is used as a power supply system for charging remotely or providing electricity directly.

10. A magnetic induction and energy storage device comprising:
(i) a magnetizable core comprising at least two magnetic objects of low hysteretic coefficient material, wherein the objects are aligned at perpendicular angles to each other to store the induced current; and
(ii) a coil, which is wrapped around the magnetizable core based on the three axes (X, Y and Z) or any two of the three axes to generate an induced current.

11. The device as claimed in claim 10, which further comprises a rectifying circuit.

12. The device as claimed in claim 11, which further comprises a battery or capacitor to store the induced electricity.

13. The device as claimed in claim 10, wherein the magnetic objects are in a shape of column.

14. The device as claimed in claim 10, wherein the magnetic objects are selected from the group consisting of soft magnets, cobalt and nickel.

15. The device as claimed in claim 10, wherein the coil is a high frequency multiple wire.

16. The device as claimed in claim 15, wherein the coil has two coils for wrapping independently around the magnetizable core based on two of the three axes.

17. The device as claimed in claim 15, wherein the coil has three coils for wrapping independently around the magnetizable core based on three axes (X, Y and Z) of.

18. The device as claimed in claim 10, which is operably connected to a biosensor.

19. The device as claimed in claim 18, wherein the biosensor is a biosensor positioned in a living organism.

20. The device as claimed in claim 19, wherein the biosensor is a charge-coupled device, a pacemaker or a powering miniature valve or a switch for long-term in vivo inspection.

21. The device as claimed in claim 10, which is operably connected to a toy or a household appliance.

22. The device as claimed in claim 21, wherein the appliance is an automatic vacuum cleaner.
